(19) United States
(12) Patent Application Publication
(10) Pub. No.: US 2008/0070206 A1
(43) Pub. Date: Mar. 20, 2008

(54) System and method of collaboration among commercial, educational and individual interests

(75) Inventor: Sandra Perilli, Cherry Hill, NJ (US)

Correspondence Address: FLASTER/GREENBERG P.C.;8 PENN CENTER, 1628 JOHN F. KENNEDY BLVD., 15TH FLOOR, PHILADELPHIA, PA, 19103, US

(73) Assignee: FolioFly, LLC, Cherry Hill, NJ (US)

(21) Appl. No.: 11/899,310

(22) Filed: Sep. 5, 2007

Related U.S. Application Data
(60) Provisional application No. 60/842,403, filed on Sep. 5, 2006.

(51) Int. Cl. G09B 19/00; G06Q 90/00

(52) U.S. Cl. 434/219; 705/9

(57) ABSTRACT

Methods are provided for collaboratively networking among a business entity, an educator and a student and for providing experience to students. The method of collaborative networking includes a business entity posting an Online Internship Activity; an educator assigning the Online Internship Activity to a student; the student creating an activity result responsive to the Online Internship Activity; and the educator submitting the activity result for consideration by the business entity.

### CROSS-REFERENCE TO RELATED APPLICATIONS

This application claims the benefit under 35 U.S.C. § 119(e) to U.S. Provisional Application No. 60/842,403, filed Sep. 5, 2006, the entire disclosure of which is incorporated herein by reference.

### BACKGROUND OF THE INVENTION

This invention pertains to a system and method for collaboratively networking among commercial, educational and individual interests, particularly among business entities, teachers and students, to provide a forum to connect and jointly prepare students for entry into a competitive global economy. One embodiment of the invention provides a system and method for an industry professional to submit “Online Internship Activities”, which a teacher integrates into daily lessons and assigns to students, who complete the activity and gain useful experience. A teacher may use this forum to submit exceptional Online Internship Activity results for business entity review, incentives and/or an amount of value with the intention of creating portfolio-building career experiences for the student including internship opportunities and freelancing options. There is currently no centralized means for teachers nationwide to connect with industry professionals interested in working with the educational system to develop students.

Some forms of collaboration have existed between business organizations and educational institutions. Business entities have funded research projects at educational institutions, where students have conducted the research. The business benefits from the research, and the student benefits from the experience gained in conducting the research, in addition to satisfying educational requirements for a degree or a diploma.

While educational institutions have various means for educating students, the internet has enabled distance learning. U.S. Patent Application Publication No. 20020069189 A1 describes a system that provides a learning system utilizing an expert training system to provide a cognitive educational experience. The system provides the user with a simulated environment that presents a business opportunity to understand and solve optimally. Mistakes are noted and remedial educational material presented dynamically to build the necessary skills that a user requires for success in the business endeavor.

U.S. Patent Application Publication No. 20030064351 A1 describes an educational method that integrates technology with the creative process to guide students in creating their own stories and art collected in a thematic anthology, produced as a digital book accessible from a CD-ROM or other memory device. Students and teachers are guided through the creative process, using a selected theme integrated with curriculum, a visiting author, and the creative process including brainstorming, research, drafts and revision, to develop a literary work accompanied by the artwork of those students contributing to the literary work. The compilations are organized into a digital book anthology, and may be saved on a memory device such as a magnetic disk or CD.

There are many ways in which business organizations identify students for internship, freelancing and other career building opportunities. The internet provides a means for entities or people, seeking qualified individuals with specific career experience, to find people who are willing and able to provide experienced services. Freelancers work independently of business organizations and provide a variety of services for business entities. General freelancing websites are available on the internet and provide a means for connecting individuals or entities seeking other relevant individuals or entities with a desired skill set to address and/or complete a specified task and/or project. Many students are eligible to participate in these services along with experienced adults.

U.S. Patent Application Publication No. 20020161619 A1 describes a method for arranging temporary project work using the internet, which includes posting a project description on the internet, receiving a request via the internet from a prospective worker to be considered for the project, and making project training available to the prospective worker, for example, via the internet. A project package may be transferred to the contract worker via the internet, a completed project package may be received from the contract worker via the internet, and an electronic payment may be authorized on behalf of the contract worker via the internet upon receiving the completed project package. This method is available for use by all eligible individuals, including students.

In addition to web-based endeavors, various efforts have been made to integrate real-world business experience in educational programs. U.S. Patent Application Publication No. 20060129448 A1 describes a method of structuring a program for developing in a group of students a set of life management skills. The method comprises providing a board to manage the program and a funding sub-program for acquiring funds from a group of sponsors including educational institutions, government entities and sporting, business, service and recreational organizations to provide physical and intellectual activities for students. Students may apply inventive thinking skills to develop new products, and a business organization may provide employees to act as mentors to the students.

Although much has been done with regard to collaboration between business entities and educational institutions, improvements can be made. Business entities continue to require new qualified and experienced leaders and contributors for their company. Educational institutions continue to search for innovative ways to prepare students for life beyond the classroom, and educational institutions, public schools in particular, seek new sources of revenue. Also, in our increasingly competitive world, students need educational experiences that truly prepare them for earning a living.

### BRIEF SUMMARY OF THE INVENTION

The present invention provides a system and a method for collaboration between commercial, educational and individual interests, particularly among business entities, teachers and students, where a business entity essentially helps to develop and prepare students for a career in conjunction with the education system. The student gets actual business-related experience and access to career opportunities, and the educational institution gets access to modern world activities, as well as a forum to connect with local and national businesses to promote and encourage students in an educational capacity. In one embodiment, the business entity posts an Online Internship Activity on a website owned, operated and promoted by a service provider. The post states the parameters for the activity, including an activity description, an incentive or award that will be paid for any activity results selected for real world use and a deadline for completion. A typical activity may be a research and writing project. Preferably, a teacher reviews the submitted Online Internship Activities, which is one of many activities from different business entities or industry professionals, and selects an activity for use as a student assignment. The students complete the assignment and generate activity results that meet or exceed the parameters of the activity. The teacher receives the students' activity results and may choose to submit the best result(s) to the business entity or industry professional through the service provider to promote a student talent. The service provider posts the completed activity results in a website inventory page, where the business entity can view a sample of the results. A number of teachers from a number of different schools may submit completed activity results in response to an activity challenge. The business entity or the industry professional preferably chooses and purchases a submitted result for real world use. The purchase amount preferably goes to the student's school for distribution at the school's discretion. Activity results that are not purchased within a certain timeframe are preferably deleted from the system for appropriate teacher resubmission in general inventory or another activity at a future date.

Included herein is a method for collaboratively networking among a business entity, an educator and a student, comprising: a business entity posting an Online Internship Activity; an educator assigning the Online Internship Activity to a student; the student creating an activity result responsive to the Online Internship Activity; and the educator submitting the activity result for consideration by the business entity.

Also included is a system for collaboratively networking among a commercial person, an educational person and an individual, comprising: a computer system operated by a service provider; an interface to the computer system that can be used by a commercial person, an educational person and/or an individual, wherein the computer system is adapted to allow the commercial person to input an Online Internship Activity; wherein the computer system is adapted to allow the educational person to see and/or hear the Online Internship Activity; wherein the computer system is adapted to allow the educational person to submit at least one activity result made by the individual; and wherein the computer system is adapted to allow the commercial person to see and/or hear the at least one activity result.

A method is also included herein for providing experience to students, comprising; posting an Online Internship Activity, wherein a first person posts the activity, and wherein the activity provides requirements for completing a task; selecting the activity, wherein a student selects the activity; completing the activity, wherein the student completes the activity by forming at least one activity result; reviewing the at least one activity result, wherein a second person reviews the at least one result; and submitting the at least one result so that the first person can review the at least one result.

Finally, included herein is a method for collaboratively networking among a business entity, an educator and a student, comprising: the business entity posting an Online Internship Activity; the educator assigning the Online Internship Activity to the student; the student creating at least one activity result responsive to the Online Internship Activity; the educator submitting the at least one activity result for consideration by the business entity; and the business entity buying the at least one activity result for an amount of value and/or offering a traditional career experience.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown. In the drawings:

FIG. 1 is a flow diagram showing an embodiment of the inventive method.

FIG. 2 is a screen print of an internet web page depicting an Online Internship Activity submission form, according to the present invention.

FIG. 3 is a screen print of an internet web page depicting the Online Internship Activity search and select method, according to the present invention.

FIG. 4 is a screen print of an internet web page depicting the Online Internship Activity results submission method, according to the present invention.

FIG. 5 is a screen print of an internet web page depicting a general inventory submission area, according to the present invention.

### DETAILED DESCRIPTION OF THE INVENTION

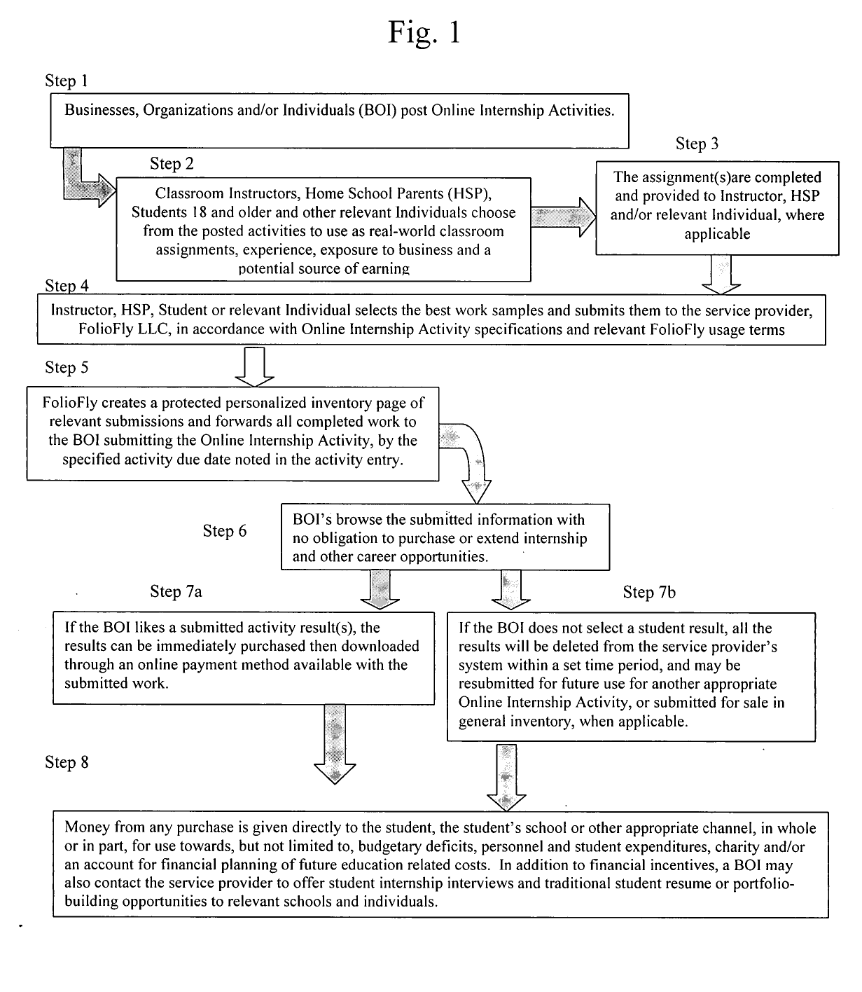

With reference to FIG. 1, one embodiment of the present invention is set forth as a series of steps. In a step 1, businesses, organizations and/or individuals (BOI) post Online Internship Activities. The activities set forth the parameters for a particular activity challenge submitted by the BOI. The activities can pertain to any type of student business challenge, such as a research and writing assignment, a graphical design, art, ideas, an invention to solve a problem, an article, a review of a book, movie or a restaurant, feedback on a slogan or an advertisement, search work such as searching the internet for information and a myriad of other challenging activities. The activity parameters stated in the Online Internship Activity preferably describe the activity challenge, note the guidelines considered helpful in completing the project and a due date to submit any exceptional activity results for BOI review.

In a preferred embodiment, the Online Internship Activities are submitted to and displayed in an internet website that is designed, built, operated and maintained by a person, typically a business entity, who provides services according to the present invention, and who is referred to herein as a service provider. The service provider advertises, markets and promotes a collaboration between the business entity, teachers and students in a manner that benefits each of these parties. The service provider can operate for profit as described below or as a nonprofit organization.

Classroom instructors, home-school parents, students of age 18 and older and other relevant individuals (referred to collectively as teachers) choose from the Online Internship Activity challenges to use as real-world classroom assignments, experience, exposure to business and a potential source of earning in step 2. For example, a college teacher may browse through an internet website listing Online Internship Activities from various business entities and choose one activity to use as an assignment for a class of college students. In step 2, an Online Internship Activity is selected by a teacher and assigned to one or more people, who are typically students. Alternatively, students 18 and older may also choose one or more Online Internship Activities out of a plurality of activities that are offered.

In step 3, the educational assignment is completed and given to the teacher (where applicable), as a completed activity result. Preferably, the teacher would have assigned the activity to a number of different students, in which case the teacher selects what he or she considers the best activity results. The teacher submits what he or she considers the best activity results to the service provider in step 4. The teacher should confirm that the activity results satisfies the parameters set forth by the business entity and submit the activity results according to terms and conditions set forth by the service provider.

The service provider receives the submitted Online Internship Activity results and preferably reviews it. Assuming there is a review and that the activity result is found satisfactory, the service provider saves the result, preferably creating a personalized inventory page of relevant submissions in step 5. Also in step 5, the service provider forwards one or more completed activity results to the business entity who submitted the Online Internship Activity challenge, preferably within an activity due date noted in the activity. In step 6, the business entity browses the submitted activity result(s) and determines whether to purchase a result submitted in response to an activity, and/or to extend an invitation for an internship interview or other career opportunity.

If the business entity selects a submitted activity result, the result can be immediately purchased and downloaded through an online payment method in step 7a. The method of payment available can be described in text accompanying the activity result. However, if the business entity chooses not to select and purchase an activity result, the result is in step 7b deleted from the service providers system, and may be resubmitted by a relevant individual for future use with another activity challenge. Where applicable, activity results may be submitted into a general inventory marketplace, where student works such as logos, art and illustrations are available for purchase and can be browsed at any time by a potential buyer. The service provider may choose to limit access to general inventory and may require potential buyers to become members. Any student work product that is purchased, whether directly through step 7a or out of general inventory, is for a buyer to own and use at their discretion.

In step 8, money from any purchase of an activity result can be given directly to the student, to the student's school or to any other person or entity, in whole or in part. Preferably, the money should be used for, but not limited to, budgetary deficits, personnel and student expenditures, charity and/or a savings or investment account for the student's future education expense. Establishing a partnership with a bank that holds monies on behalf of a student or educational system for an established period of time is an option. Along with incentive payment, business entities may also extend offers through the service provider requesting internship interviews and other career opportunities based on exceptional student results.

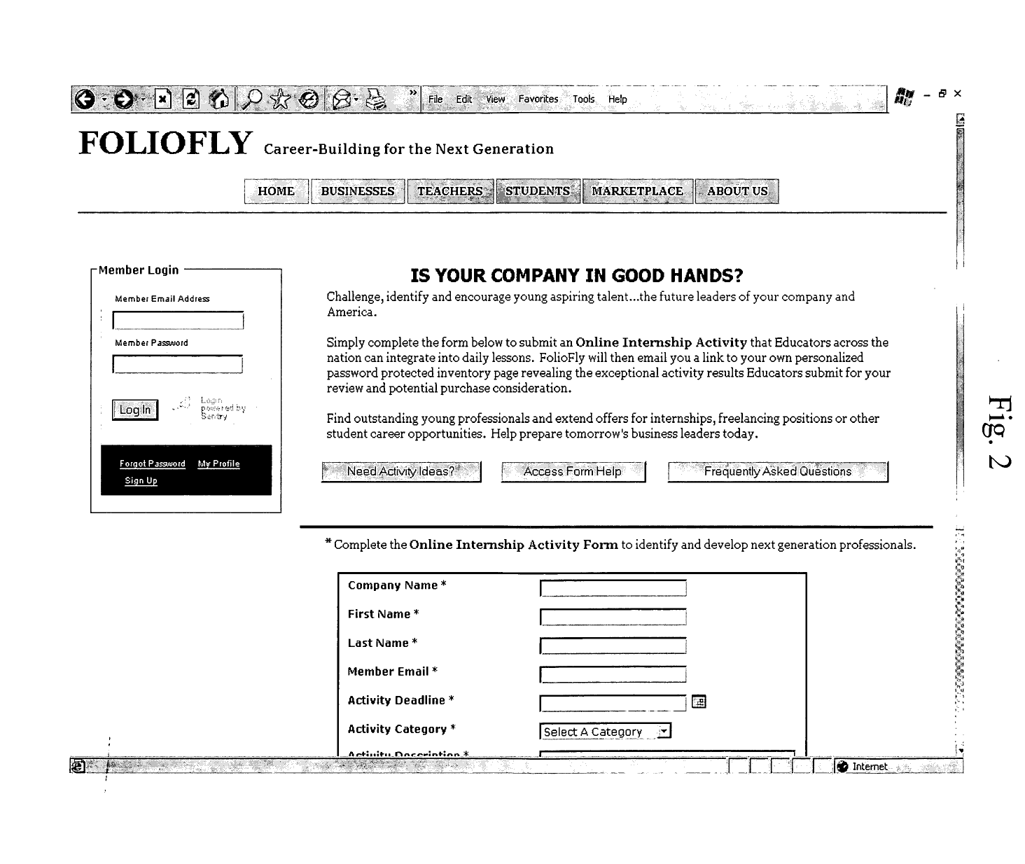

Turning to the remaining figures, one embodiment of the present invention is illustrated in several web pages that can be used to implement the invention. With reference to FIG. 2, an Online Internship Activity submission form is illustrated according to the present invention. This activity submission form or web page outlines the benefits of a business entity submitting an activity, and provides instructions for completing and submitting the Online Internship Activity form. The top and bottom of the web page, as seen on all service provider web pages, provides access to or a link to frequently asked questions (FAQs), an entry point for browsing a selection of existing student work products in general inventory for purchase consideration, a help section providing a search point for entering key words to search the website, contact information for the service provider, teacher access to search and select submitted Online Internship Activities, student access to submit work(s) for sale in general inventory and an About Us link describing the service providers invention concept.

The lower portion of FIG. 2 illustrates how the business entity submits an Online Internship Activity through the inventive method. A business entity enters information into the form and submits the form to an information database owned and operated by the service provider. The business entity enters information such as the name of the business entities company, the business entities personal name and title, an activity category such as Writing, Graphics or Design, an area to provide a brief description of the activity challenge, which sets forth the parameters for an activity result that would be submitted in response to the activity entry, an activity due date establishing when the service provider stops accepting new activity result submissions, an incentive or award, which is an amount of money that the business entity will pay to use and own exceptional student activity results, and a field into which the business entity can upload additional notes, comments or images, which may be used to further set forth and clarify parameters for the activity challenge.

In one embodiment, an instructor, advisor or teacher reviews the Online Internship Activities submitted by a business entity and selects an activity to assign to a class of students. Each student works on the assignment to create an activity result that satisfies the parameters of the activity. Each student turns his or her activity results into the teacher. The teacher typically grades the activity results of each student as would be done for any project assigned to students. If the teacher receives exceptional student results, the teacher may submit the result(s) to the business entity for review. Alternatively, the teacher may assign the activity to a single student for completion as an individual project or activity, such as an individualized, semester-long research project. Activities can be assigned on a voluntary basis to students who want specific career portfolio building experiences, and who seek internship and other related opportunities. A student in any case may be in high school, college, graduate school, professional school or at any other level.

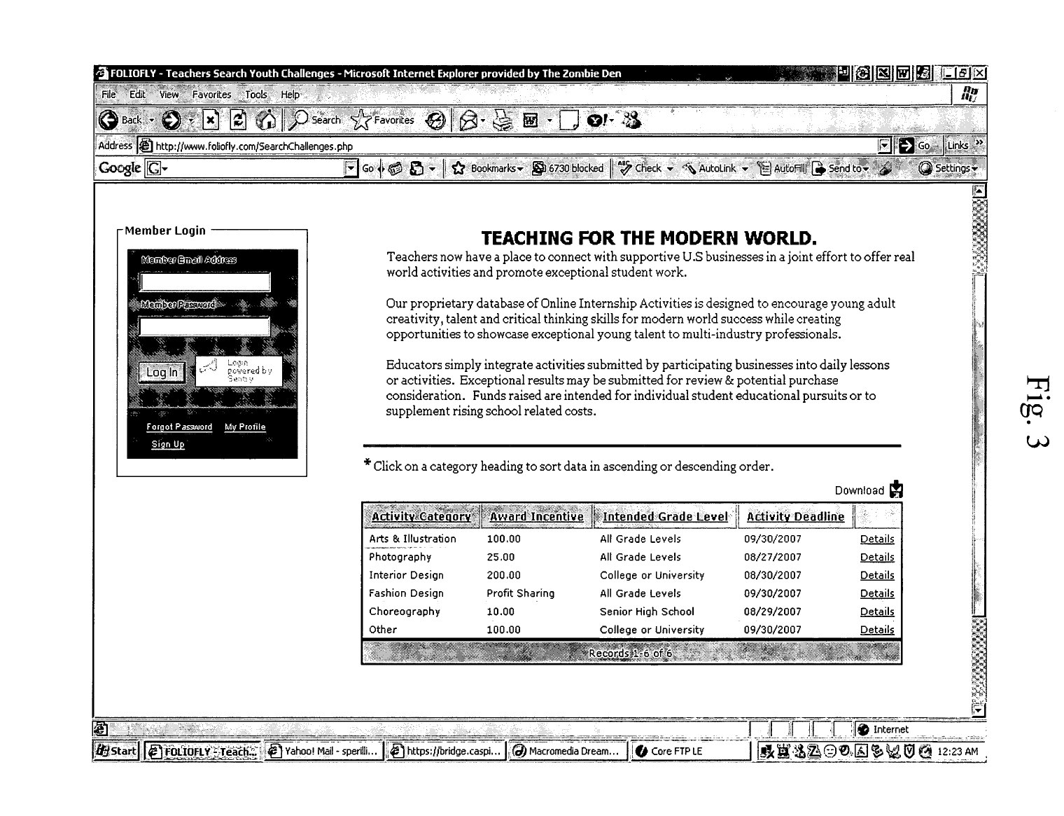

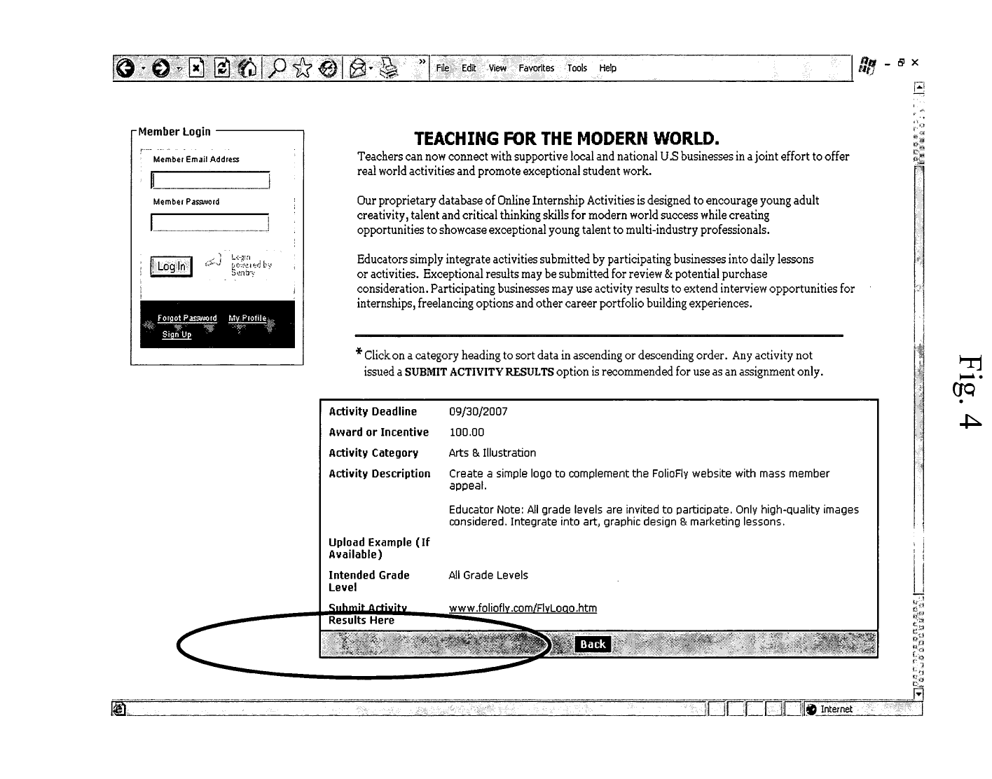

Turning to FIG. 3 and FIG. 4, an Online Internship Activity search and submission table is provided as a web page and one embodiment of the present invention. FIG. 3 shows a teacher how to use the Online Internship Activity search and submission table, and FIG. 4 shows a detailed activity view where a teacher can submit activity results to the service provider. Activities submitted by a business entity for assignment purposes only do not possess a method to receive activity results for submission. Activities not approved by the service provider may be posted for assignment use only and not possess a method to receive activity results for submission.

In FIG. 3, the teacher can browse the existing database of Online Internship Activities. The teacher can select an activity to use as an assignment for students. After the students have completed the assignment and created a result, the teacher has an option of choosing what he or she considers the best result(s) and submits the result(s) to the business entity. The results submission can be sent to the service provider for posting for the business entity to review, or the submission can be direct to a website for the business entity to review the activity result(s). Upon submitting activity results, the teacher receives a confirmation email stating that the submission was received and will be posted for the business entity to review. All submissions to a single Online Internship Activity may only be submitted one time, should be original, should not have been previously sold, under contract for sale or submitted in response to a previous contest.

With reference to FIG. 3, a teacher is any person licensed to teach students any subject, in any state, in any school. The school can be elementary school, middle school, high school, undergraduate college or a university for graduate and professional students. The schools can be in either the private or the public sector. The teacher need only be interested in supplementing classroom assignments with valuable business-related experience. A teacher is told he or she can earn cash for his or her school through everyday assignments to teach students things that have real meaning and usefulness in the business and professional world outside of school. Adults, such as college students, can submit activity results and earn money and connect with businesses for career opportunities through the service provider. The internet website can be designed to accommodate submissions by individuals that have home-schooled students, as well.

Teachers can submit Online Internship Activity results using the submission method provided in FIG. 4. The teacher selects the “Submit Activity Results Here” option to upload and submit the results in a file or image format. The teacher enters his or her school's name, his or her name and title, an Online Internship Activity number assigned by the service provider to link the activity results to the activity and any notes or comments. Uploaded file(s) can be sent to the service provider via an email with a hyperlink to an encrypted password protected personalized inventory page for the business entity to review. In another embodiment, this can be automated so that the activity results are submitted automatically and directly to the business entity for review. Activities with no result submission capabilities are to be used for assignment purposes only. No incentives or career opportunities are affiliated with these particular activities.

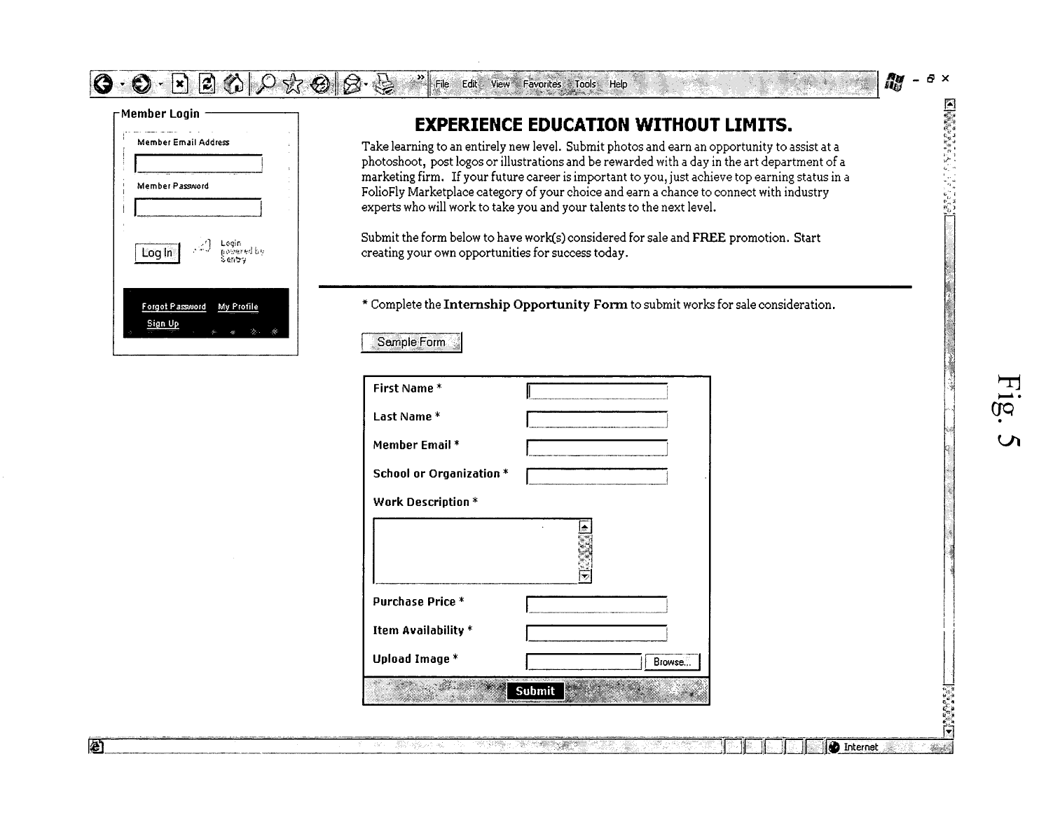

Turning to FIG. 5, a general inventory submission form is provided, which allows any student member, or member acting on behalf of a student, to submit a work product into general inventory for sale consideration that is not in response to any Online Internship Activity. A general inventory submission form can be used to submit an activity result that was completed in response to an Online Internship Activity submission but not purchased by the business entity. For example, a college student may browse activities and create a work product for direct submission to and consideration by the business entity, although such work product is preferably reviewed and approved by the service provider before the business sees the work product. The relevant individual may use the general inventory submission form to submit work into general inventory not purchased by a business entity (if applicable).

The general inventory submission form of FIG. 5 provides a description of benefits for students who use the service provider, and provides the general inventory submission form in the lower portion of the web page. A link to general inventory is provided where there is a search input area for searching the website and a point-and-click area for browsing work product that is in inventory. Inventory is categorized into topics such as logos and stock photos; web site templates; cartoons & illustrations; research; fashion design; toy and product designs; music; and miscellaneous student services. New categories can be requested and made available.

Submission requirements are provided in a link to Site Terms found in FIG. 5 and on all service provider web pages. Submission requirements include a review by an instructor, when appropriate, for quality, including correct spelling, proper punctuation, proper use of grammar, satisfaction of parameters noted in the Online Internship Activity and overall activity result quality including the appearance of the work product. Work product can only be removed from general inventory upon request to the service provider. The ability to remove inventory can also be automated so the teacher or student may directly remove a submission from the general area.

The general inventory submission form of FIG. 5 has data input points similar to the Online Internship Activity submission form of FIG. 3. The data input points ask for school name, submitter's name and title, a description of work being submitted, an uploaded file or image of the work, an established price by which to sell the work, number of available work items and any relevant notes and comments.

With respect to items in general inventory, as well as in completed activity result submissions to business entities, any suitable method can be used to protect the items from unauthorized use. For items submitted to business entities, one can monitor downloads to determine whether an item has been taken. A small portion of an activity result, such as an abstract or a single sheet, can be displayed and the entire work product can be delivered upon receipt of payment. Access to inventory can be limited to members, and it may be possible to encrypt an activity result so that it can be seen but not otherwise used. Full result disclosure will be made to known and reputable businesses.

As an alternative embodiment of the present invention, a teacher or a person in a similar position can post an activity that his or her students can do. For example, a teacher may be teaching a computer graphics class and want to have company logos to make or similar graphical applications. The teacher can post on the website a description of what will be taught in the class and solicit real-world activities from the business and professional community. In response to the teacher posting and solicitation, a businessman or a professional would respond and post interest in supporting the activity either online or connecting face-to-face to create a resume or portfolio building experience. The teacher would choose the relevant business and business activity for his or her students, who would use the activity as part of their education and training. The teacher receives and reviews the students' activity result(s), and results deemed acceptable is passed to the business entity, preferably through posting on a service provider's website as described above.

In one embodiment, the service provider is viewed as providing a server and software for implementing the invention described herein. In this embodiment, the business entities and the teachers have client computers that are networked, typically through the internet, with the service provider's server computer. Alternatively, a peer-to-peer computer network can be used to implement the present invention. In a peer-to-peer network, each participant's computer is networked, typically through the internet, to each other participant's computer, and computing power is provided by the various participants' computers rather than by a central server provided by the service provider. In the peer-to-peer computer networking embodiment, the service provider provides software to the participants to implement the present invention.

Turning now to a further explanation as to how the present invention works, the service provider provides a web-based service that unites business entities, organizations, individuals and educational institutions. The service includes, but is not limited to, the following services. The service generates opportunities for students to obtain real business experience and develop skills needed to excel as adults by providing access to tangible skill building exercises in the form of Online Internship Activities and long or short term activities that can be conducted remotely. Activities may be obtained online, at schools, human resource centers and other avenues. Activities create opportunity to expose students to different types of work in different industries, and offer teachers a forum to connect with the business community to promote and encourage talented student development and career growth.

The service enhances classroom instructor assignment selections by providing access to true business related activities provided by supportive U.S. businesses. This exposes students to a multitude of careers to gain valuable insight regarding what is required to complete work in the business world, and/or for meeting work deadlines for relevant businesses, organizations or individuals expecting specific work results. The service generates an alternative business solution of identifying and readying interns, student freelancers and young Entrepreneurs to enter the modern global economy. The service can lower school budget deficits and control education-related expenses by leveraging multi-industry dollars through earnings generated by student and all relevant individuals using the inventive services. The service also connects teachers with businesses who want to work with the education system to develop next generation professionals.

The inventive service can be delivered using the following means. The service can develop a searchable, categorized index of dynamic content consisting of Online Internship Activities to be leveraged as classroom assignments, student freelancing opportunities and/or method of exposing individuals to different career types. Online interns can be used as a means of collecting modern intelligence and to help generate ideas from a fresh pool of talent.

The service can create an interest in the educational community looking to obtain and utilize business related classroom assignments intended to provide an enhanced learning experience for the students while earning financial incentives towards education related expenditures. The service is primarily designed to, but not limited to, assist schools with intense budgetary issues, local towns with high educational taxes and to create new opportunities for meeting a law known as No Child Left Behind. Participating schools may be provided an opportunity to directly donate the financial incentives they make, in whole or in part, to charity on behalf of their school. The service provides a dynamic database of activities from business entities including, but not limited to, publishers, agents, news media outlets and other interests looking to help develop talented students and offer resume and portfolio-building career opportunities and experiences.

Areas of business that may be leveraged include, but are not limited to the following.

Logos: Logos can currently be purchased on the internet ranging from free low-end images to hundreds of dollars for a sampling of multiple images; the price is even higher when revisions are included. Aspiring Art and Computer Graphics students, for example, will be able to respond to Online Internship Activities for company, organization and individual logos for a set price established by the relevant entity.

Stock Photos: Companies of all sizes and types are legally obligated to use photos they either own or are leasing rights to own. Not all entities are willing to pay a lot of money for a high quality photo. Aspiring photography students, for example, will be able to respond to specific photo activities and earn financial incentives as they build a portfolio from purchases for a price established by the relevant entity. Students may also simply post their images for sale in a general stock photo inventory

Greeting Cards: Greeting card sayings and poems can command hundreds of dollars if accepted by some of the better-known establishments such as http://www.sps.com/greetingcards/index.htm. Aspiring writers or students interested in graphic arts and illustration, for example, will be able to respond to specific greeting card topic activities, for a price established by the appropriate entity. Students also earn financial incentives from purchases out of our general greeting card inventory, including e-cards. Partnerships can be defined with Hallmark and other relevant businesses to create career opportunities and leverage our student inventory, where feasible.

Publisher & Author Reviews: Publishers may prefer for students to review new books instead of, or in addition to, adults because students focus on a different perspective than an adult. This creates an opportunity for publishing entities to request the type of classroom or demographic (urban, rural, Hispanic, etc. . . . ) they want to target and for a fee the business or entity offers, any Instructor or relevant individual will be able to sign their class up to review the book(s). Depending on the book level, either the teacher or the students will submit the reviews.

Research: Authors, scientists, individuals and business of all types require basic research such as statistics, general information and ideas. Students of all levels present research papers for classroom assignments daily. The research completed is typically not utilized, but Instructors and/or relevant individuals can post their best research works for purchase by people interested in obtaining that specific type of research material. The Instructor, student and/or relevant individual can establish prices on general inventory items.

Essays/Articles/Cartoon Strips: Magazines and newspapers are constantly searching for new writing, materials and images. Their normal resources include the AP, Bloomberg and PR Newswire. With the present invention, an inventory of student writing can become another viable source to obtain essays, articles, editorials and illustrations from a fresh and expansive new market.

Short Stories: Innovative creative writing is becoming a rare commodity. There is a lack of sitcoms, good movies and interesting television. Students are given writing assignments each day that generate insightful, current and engaging material. Individuals create writing every day that is never seen or used. Instructors and/or relevant individuals provide students and the like with great grades, some may pursue submitting the writing to an Industry Professional they know for further consideration as a television episode, children's book or similar project. Aspiring writers and Instructors will now have a place to turn to submit excellent writing assignments, and Instructors have a place to provide students with specific writing assignments based on real world writing activities regardless of personal industry contacts.

Song Lyrics & Scores: Students interested in all aspects of music can respond to Online Internship Requests seeking songs, musical scores or simple jingles.

Film Shorts: Businesses seeking to innovative ideas for commercials or videos on specific topics can either turn to the general inventory of student generated film clips or submit a specific Online Internship Activity to be utilized as a classroom assignment.

Some additional areas that may be leveraged include, but are not limited to, web design templates; fashion designs jewelry, clothes, accessories, etc. . . . ); and other topics introduced by registered service provider members or staff of the service provider and/or submitted by an outside party through email, US mail, phone and/or other means of communication.

Thus, a business entity can be any company or person legally established in the U.S. willing to submit activities and spend time reviewing exceptional results for potential purchase consideration, or to consider extending student internship, freelancing or other career opportunities. In particular, a business entity can be an employee of a business entity, a doctor, a lawyer, an architect, a graphics designer, an artist, an individual, a business owner, a professor, a television producer, a script writer, an advertising professional, a photographer, a writer, a cartoonist, a song writer, a researcher or a myriad of other people.

Certain features, including but not limited to the following, may be incorporated into the service provided according to the present invention. A same or similar adult and/or non-student version of the inventive service for individuals that are interested in obtaining career experience and/or exposure to new career choices while earning financial incentives or points/incentives and experience from a larger program for work performed.

Partner with a bank or other type of financial institution as an extension for handling the financial aspects of online and offline business transactions for the service.

Personalized inventory pages may be one avenue for displaying specific activity results to Online Internship Activity challenges, but other potential communication avenues include, but are not limited to direct email submission of completed results by relevant individuals, traditional mailing, video or audio portals and other similar or different communication technologies.

Online and offline surveys, quizzes, questionnaires and/or documents and programs of that nature will be offered to assist relevant individuals in determining career options, relevant skill sets, talent and/or experience(s) associated with a particular job or career path.

Links or offerings to resources, including but not limited to, static and/or dynamic data, knowledge and information relating to various job and career path options, social and business etiquettes to hone and advance educational, personal, financial and career choices.

Offer the services of an online guidance counselor to help direct relevant individuals in maximizing use of the services, online and offline.

Future site enhancements will include, but will not be limited to, partnering with entities that allow for credits or incentives earned by relevant individuals to be applied towards school credit(s) and/or traditional internship and educational community service hours.

Personal Membership Accounts for all relevant individuals will eventually track activity results and general inventory submitted, selected and/or rejected; feedback ratings for students and teachers submitting results, financial incentives earned or paid; relevant statistics indicating which types of activities the relevant individual is showing a proclivity towards; suggesting other similar or relevant activities and/or career opportunities for consideration; identified individuals or school systems that are rated based on their contributions against other schools or relevant individuals; and email alerts notifying members when new activities or industry information resources are available through the service provider.

The service provider will use collected site and general member statistics as a means of deciding upon incentives for being outstanding members and showing contribution as a school, state, business, organization and/or individual, as well as for determining site improvements.

The service provider will provide an optional area for feedback, suggestions, tips, hints and the like stemming from a members experience using the invention.

Allow personal profiles of each member to track individual credentials; businesses, organizations and/or relevant individuals posting Online Internship Activities can specify a particular level and/or type of school or other credential from which they would like to encourage participation.

The service provider may offer online resume building for students and relevant individuals as their work, research and project experience grows along with the activities they are involved with. Students' work, research and project experience from creating activity results in response to activities can be used in college applications, and the service provider can provide an online resume that captures this as a working trail of experience and skills that can be used in the college application process. Online resume building will also allow students to capture other experience, education, training, achievements, awards and accomplishments that can be used in writing college applications and college essays.

The service provider may partner with colleges or other relevant institutions to give a certain amount of credit or other item of value to a student for exceptional Online Internship Activity results successfully completed by the student and identified as such by a teacher and business entity. The work can be for any activity specified herein, but activity results derived from research and writing projects may be particularly appropriate for college credit. The service provider may also offer college information and reviews on schools, preferably written by students, as well as contests and such that are sponsored by businesses or other relevant entities granting money to outstanding student members based on established contest or grant criteria.

How does the software interface work and how are financial transactions tracked? In one embodiment, the website leverages a Yahoo Merchant Solutions Online Store for the posting, handling and purchase of electronic work submission files submitted by all relevant individuals. One preferably uses the most appropriate technology solution(s) for managing the data, information, knowledge and overall need for communications associated with service's disclosed business networking method. Financial transactions can be made using a standard software solutions online payment package currently compatible with the Yahoo Merchant Solutions Online Store. Configurations should be set by the relevant individual who uses the services for the purpose of providing feedback on the ease of use and identified pros and cons of use. Additional enhancements to the handling of financial transactions can include partnering with a bank or other financial institution to manage such areas including but not limited to educational funding, business partner sponsorships and other related monetary and/or incentive transactions.

Some aspects needed for the inventive service include, but are not limited to, the following:

Purchase a web-based E-commerce store through an established online store service provider. E-commerce store should have ability for file search and browse functions, support of file upload and download activity, offering secure email, as well as handling and tracking of financial transaction data.

Website front-end should include text fields to process the following form types:

General Inventory Submission Form—This form may be used to submit work for sale consideration into General Inventory. Input of information includes, but is not limited to, School name, Member Name, Member Title (Instructor, Student, etc. . . . ), Description of Work for sale, File Upload of image or document, Established Purchase Price, Item Availability (if applicable) and any relevant Notes or Comments.

Online Internship Activity Submission Form—This form may be used to submit activities in order to connect with and support the educational system in offering students incentives and resume and portfolio building experiences. Input of information includes, but is not limited to, Company or Organization name (where applicable), Member Name, Member Title, Activity type, Activity Due Date, Payment Price (price/incentive that will be paid for selected results) and Instructions/Directions/Comments.

The website front-end should provide a searchable and categorized list of all submitted Online Internship Activities and general inventory submissions and should tie into an appropriate back-end that connects to a dynamic database that handles the relevant database requests. There is no preferred programming language to tie the front-end and back-end together, but one may use PHP/MySql or AJAX as a programming interface. The system should have the ability to track membership login information and other related site and service activities including, but not limited to, Member Login; access to all posted Online Internship Activities and General Inventory submissions; a General Inventory Submission Form that allows any relevant individual to submit work and/or upload work, complete or incomplete, for sale or purchase consideration by another party for use as is, or to revise, as needed; and an Online Internship Activity Submission Form that can be used by relevant individuals to submit specific activity challenges in order to receive completed work responses for review, potential purchase consideration and to identify potential students for internship and career opportunities.

The online store provider provides website building tools allowing for the connection to a database back-end, but database outsourcing to a third party is also an option. Some hosts will not offer this level of technical support so a separate resource(s) should be secured to appropriately handle implementing this aspect of the invention.

Completed Online Internship Activity results submitted to business entities via the service provider is preferably submitted in the form of a Personalized Inventory Page (PIP) sent directly to the business, organization and/or relevant individual's email inbox, post office box, residence or other stated location. The PIP is where the completed submitted activity results can be viewed, purchased, downloaded or bypassed, as applicable. Information contained within the PIP includes but is not limited to: A sampling that is representative of the work (entire works may not be disclosed due to piracy concerns), Title of work (if applicable), a Feedback option, an electronic payment option for immediate purchase of file and download. All work not selected for purchase by the business entity is deleted from the service provider system after a set period of time, and may be resubmitted by the relevant individual for another activity challenge or for placement into general inventory for browsing and purchase by another business or relevant individual, when applicable. Preferably, each Personalized Inventory Page can only be viewed and purchased by the specific business entity for a period of 15 (fifteen) days. This method of finding qualified student interns differs from existing sites that post job requests and consider bids for jobs based on work experience, cost and/or educational experience instead of receiving completed work results to consider prior to selecting and offering an individual a business related experience.

The website front-end should also provide general inventory pages that are not personalized to a specific business entity to showcase any and all works uploaded into system, and such work should be made available for search and purchase by general members. Financial transactions can be handled by an established online payment system compatible with Yahoo Merchant Solutions or may be handled through a bank or other financial institution that the service provider has a relationship with.

Access or links to a Site Terms and Agreement, Privacy Policy, a business sponsor and/or affiliation listing, a detailed step-by-step description of the invention, and a forum with information for contacting the service provider is preferably provided on every page of the website to encourage feedback, comments, suggestions for improvement and inform members on site usage.

The present invention provides a method and a system for bringing all relevant people together to create a mutually beneficial network collaboration of people in support of education. The invention:

Provides a unique collaborative solution addressing known educational, personal and financial shortcomings, including but not limited to funding education and improving upon school system effectiveness, heightening awareness and exposure to career and business options starting from an earlier age, the ability of business and organizations to identify and access high-quality interns, student freelancers and other students for certain types of jobs and job tasks exchanged for financial rewards and/or incentives.

Creates access to a fresh, untapped skill pool of talent ranging across a multitude of industries.

Generates tangible business opportunities for students and other relevant individuals seeking exposure and/or experience with different career, work and education options without any long-term obligations to any business, organization and/or relevant individual.

Provides a categorized and searchable repository of dynamic data for teachers and other relevant individuals seeking to leverage tangible opportunities as classroom assignments, homework assignments, or assignments designed to create experiences associated with the business world.

Creates an opportunity for businesses, organizations and/or relevant individuals to connect with the educational system and establish a new method and concept to expand both business and educational horizons.

Provides a general inventory for all student members and relevant individuals to showcase and sell their complete or incomplete work without having to respond to a specific Online Internship Activity; this allows participating businesses, organizations and relevant individuals to select and purchase from an inventory of work that can financially, professionally and personally benefit a student and/or school.

Creates an opportunity to positively impact education-related tax dollars and expenses by applying financial rewards earned through the service towards those causes.

Provides online payment option for immediate file download and use.

Educational and career related seminars offered as informational resource(s). Online Guidance Counselors serve to assist all members in maximizing their experience using the service and related features or affiliations. Personal Membership Accounts profile information that will track and show job related information associated with the invention including number of Online Internship Activities selected, submitted, financial rewards earned, as well as other relevant information for each relevant individual.

Student resumes or interviews may be requested by business entities in consideration of traditional internships after work from a particular student or relevant individual has been previously selected for purchase.

Personalized Inventory Pages displaying completed or partial activity results submitted in response to Online Internship Activities are submitted directly to a business entity by the activity challenge end date he/she specifies.

Unlimited selection of searchable inventory categories; New categories for submission are created upon request.

Does not typically obligate any member to purchase or pay a membership fee. Financial transactions are primarily limited to any activity results or general inventory work selected for purchase.

Provides links and/or offerings for professional freelancers, ghostwriters, consultants and/or contractors who utilized the service provider as a student.

Provides surveys, quizzes, questionnaires and other document or informational program types used to assist in determining career options, relevant skill sets, talent and/or experience required or associated with a particular job or career path. Provides flexibility in that Online Internship Activities posted and/or submitted for review can be any task or project of legal nature, short term or long term.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A method for collaboratively networking among a business entity, an educator and a student, comprising:
a business entity posting an Online Internship Activity;
an educator assigning the Online Internship Activity to a student;
the student creating an activity result responsive to the Online Internship Activity; and
the educator submitting the activity result for consideration by the business entity.

2. The method according to claim 1, further comprising:
the business entity buying the activity result for an amount of value.
the business entity offering traditional student business experience.

3. The method according to claim 2, wherein the educator works for an educational institution, and the method further comprises:
the educational institution receiving the amount of value.

4. The method according to claim 2, wherein the amount of value is money.

5. The method according to claim 2, wherein the amount of value is a non-monetary award.

6. The method according to claim 1, wherein a service provider provides a computerized system that enables the business entity to post the Online Internship Activity and the educator to submit the activity result(s).

7. A system for collaboratively networking among a commercial person, an educational person and an individual, comprising:
a computer system operated by a service provider;
an interface to the computer system that can be used by a commercial person, an educational person and/or an individual,
wherein the computer system is adapted to allow the commercial person to input an Online Internship Activity;
wherein the computer system is adapted to allow the educational person to see and/or hear the Online Internship Activity;
wherein the computer system is adapted to allow the educational person to submit an activity result(s) made by the individual; and
wherein the computer system is adapted to allow the commercial person to see and/or hear the activity result(s).

8. A method for providing experience to students, comprising:
posting an Online Internship Activity, wherein a first person posts the activity, and wherein the activity provides requirements for completing a task;
selecting the activity, wherein a student selects the activity;
completing the activity, wherein the student completes the activity by forming at least one activity result;
reviewing the at least one activity result, wherein a second person reviews the at least one result; and
submitting the at least one result so that the first person can review the at least one result.

9. The method according to claim 8, further comprising purchasing the activity result(s), wherein the first person purchases the at least one activity result.

10. The method according to claim 9, further comprising creating a personalized inventory page for the commercial person, wherein the submitted at least one activity result is displayed on the personalized inventory page.

11. The method according to claim 9, further comprising forwarding the at least one activity result to the first person.

12. The method according to claim 8, wherein the first person is an industry professional.

13. The method according to claim 12, wherein the second person is a teacher.

14. The method according to claim 8, wherein the second person is a teacher.

15. The method according to claim 8, further comprising declining to purchase the at least one activity result, wherein the first person chooses not to purchase the at least one activity result.

16. The method according to claim 15, further comprising adding the at least one activity result to general inventory, wherein general inventory contains a plurality of work completed by the student and/or by other students.

17. The method according to claim 8, further comprising purchasing the at least one activity result for an amount of value, wherein the first person purchases the at least one activity result, and wherein the first person is an industry professional and giving the amount of value to a school, wherein the student attends the school.

18. The method according to claim 17, wherein the second person is a teacher who teaches at the school.

19. The method according to claim 18, wherein a plurality of students chooses the Online Internship Activity and prepares a plurality of activity results, wherein the second person chooses one or more activity results out of the plurality of activity results for submission to the first person.

20. The method according to claim 8, wherein a plurality of students chooses the Online Internship Activity and prepares a plurality of activity results, wherein the second person chooses one or more activity results out of the plurality of activity results for submission to the first person.

21. The method of claim 8, wherein the task concerns a writing assignment.

22. The method of claim 8, wherein the at least one activity result is a written document, and wherein the written document is encrypted in a manner so that it cannot be used by the first person until after the work product is purchased.

23. A method for collaboratively networking among a business entity, an educator and a student, comprising:
the business entity posting an Online Internship Activity;
the educator assigning the Online Internship Activity to the student;
the student creating at least one activity result responsive to the Online Internship Activity;
the educator submitting the at least one activity result for consideration by the business entity; and
the business entity buying the at least one activity result for an amount of value and/or offering a traditional career experience.

24. The method of claim 23, wherein the educator is a parent who teaches his or her child at home.

25. The method of claim 21, wherein the business entity is an employee of a business entity, a doctor, a lawyer, an architect, a graphics designer, an artist, a business owner, a professor, a television producer, a script writer, an advertising professional, a photographer, a writer, a cartoonist, a song writer or a researcher.
